(19) United States
(12) Patent Application Publication
(10) Pub. No.: US 2006/0005221 A1
(43) Pub. Date: Jan. 5, 2006

(54) Navigation aids for television user interface

(75) Inventors: Scott Allan MacBeth, San Diego, CA (US); Pamela Lynn Covarrubias, San Diego, CA (US); Sabrina Tai-chen Yeh, Laguna Beach, CA (US); Hong Nguyen, San Diego, CA (US); Michael Donald McDermott, Chula Vista, CA (US); Philip McKay, San Francisco, CA (US); George Edward Williams, Carlshad, CA (US)

Correspondence Address: ROGITZ & ASSOCIATES, 750 B STREET, SUITE 3120, SAN DIEGO, CA, 92101, US

(73) Assignee: SONY CORPORATION and SONY ELECTRONICS, INC.

(21) Appl. No.: 11/010,209

(22) Filed: Dec. 10, 2004

Related U.S. Application Data
(60) Provisional application No. 60/585,316, filed on Jul. 2, 2004.

(51) Int. Cl. H04N 5/445

(52) U.S. Cl. 725/47

(57) ABSTRACT

Various menu and cursor arrow navigation aids are disclosed for television systems. A removable memory medium can be engaged with the TV to cause the TV to automatically display content as dictated by the medium.

### RELATED APPLICATIONS

This application claims priority from U.S. provisional application Ser. No. 60/585,316, filed Jul. 2, 2004.

### BACKGROUND OF THE INVENTION

I. Field of the Invention

The present invention relates generally to television systems.

II. Description of the Related Art

Advanced televisions typically have graphical user interfaces (“GUI”) that are presented on the TV screen and that can be navigated through using a television remote control device for various purposes, including establishing TV settings. As recognized herein, many existing TV GUI are modelled after computer GUI, but as further recognized herein many TV viewers might be less steeped in computer operation than the average computer user and, hence, might require simpler, more obvious GUI. With this in mind, various features disclosed below have been provided.

### SUMMARY OF THE INVENTION

A TV system includes a TV tuner receiving TV content and a TV monitor for displaying the TV content. A processor communicates with the tuner and monitor and can cause a graphical user interface (GUI) to be displayed on the monitor.

In one aspect, the GUI can include a main menu which has an edit favorites button which, when selected by a user, presents a GUI menu enabling a user to establish a favorite TV channels list. The main menu may be a surf favorite channels menu.

In another aspect, the GUI may include one or more computer icons including a music note icon selectable to cause a menu of audio settings to be displayed on the monitor, a video icon including a figure in a box and selectable to cause a menu of video settings to be displayed on the monitor, an applications icon selectable to cause a menu of applications to be displayed on the monitor, a channel icon including plural boxes overlaid on each other and selectable to cause a channel menu to be displayed on the monitor, a screen icon selectable to cause a screen menu to be displayed on the monitor, a parental lock icon including at least one image of a lock and selectable to cause a menu of parental controls to be displayed on the monitor, and a setup icon selectable to cause a setup menu to be displayed on the monitor.

In another aspect, the GUI may include a main menu, a second layer menu being a descendant of the main menu, and a third layer menu being a descendant of the second layer menu. The processor may cause all three menus to be displayed simultaneously on the monitor at least part of the time in a configuration such that a user can view at least a portion of each of the three menus. Further menu layers may be provided, with a fourth layer menu overlapping a second layer menu, a sixth layer menu overlapping the fourth layer menu, etc.

In another aspect, the GUI may include a main menu, a second layer menu being a descendant of the main menu, and a third layer menu being a descendant of the second layer menu, and the processor may cause only, at least part of the time, the third layer menu to be displayed when it is selected. The main and second layer menus disappear from the display. The third layer menu may be a video settings menu, and the processor can cause help text to appear above the third layer menu when the other two menus disappear.

In another aspect, the GUI may include a favorite channel list listing both analog and digital channels, with the favorite channel list being established by a user by means of, e.g., a remote control device in wireless communication with the processor and containing a numeric keypad. A desired channel can be entered into the favorite channel list by a user inputting a numeric value representing the desired channel using the keypad.

In another aspect, the GUI may include a shown channel list established by a user to display only analog and digital channels desired by the user to be shown on the list. A remote control device is in wireless communication with the processor and is manipulable by a user to select a time and a channel to be automatically played on the monitor at the selected time.

In another aspect, a remote control device in wireless communication with the processor can be manipulated by a user to select a color for at least one menu of the GUI. In some implementations one of six colors may be selected and applied to all menus in the GUI.

In another aspect, the GUI may display arrows including cursor arrows superimposed on a screen cursor, detached arrows not connected to a visible part of the GUI, and adjustment arrows displayable on an adjustment screen and respectively selectable to cause a previous and next adjustment screen of the GUI to appear.

In another aspect, a receptacle can communicate with the processor and can be configured for removably receiving a portable memory device. The processor may automatically cause an audio display and/or a visual display associated with at least data on the portable memory device to be displayed on the monitor in response to the portable memory device being engaged with the receptacle. The portable memory device may store a flag indicating to the processor to automatically establish a display. The processor can automatically establish the display using application information on the memory device, and/or using application information on a permanent storage internal to the TV system.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a first embodiment of the system of the present invention, showing the microprocessor in the TV;

FIG. 2 is a flow chart showing the logic for automatically establishing a display when a removable memory medium is engaged with the TV;

FIG. 3 is a screen shot of a display presented on the monitor, showing a main menu with an edit favorites button;

FIG. 4 is a screen shot of a display presented on the monitor, showing an edit favorites menu;

FIG. 5 is a screen shot of a display presented on the monitor, showing the setup icon selected;

FIG. 6 is a screen shot of a display presented on the monitor, showing the video icon selected;

FIG. 7 is a screen shot of a display presented on the monitor, showing the applications icon selected;

FIG. 8 is a screen shot of a display presented on the monitor, showing the audio icon selected;

FIG. 9 is a screen shot of a display presented on the monitor, showing the channel icon selected;

FIG. 10 is a screen shot of a display presented on the monitor, showing the screen icon selected;

FIG. 11 is a screen shot of a display presented on the monitor, showing the parental lock icon selected;

FIG. 12 is a screen shot of a display presented on the monitor, showing three layers of related nested menus superimposed on each other;

FIG. 13 is a screen shot of a display presented on the monitor, showing a main menu and second layer menu;

FIG. 14 is a screen shot of a display presented on the monitor as shown in FIG. 13, but with the main menu removed so that the TV video can be better seen;

FIG. 15 is a screen shot of a display presented on the monitor, showing a favorite channel menu that lists both analog and digital channels and that permits a user to input a numeric string representing a channel to be added to the list;

FIG. 16 is a flow chart showing the timer logic that can be used;

FIG. 17 is a flow chart showing the GUI color select logic that can be used;

FIG. 18 is a screen shot of a display presented on the monitor, showing cursor arrows;

FIG. 19 is a screen shot of a display presented on the monitor, showing detached arrows;

FIG. 20 is a screen shot of a display presented on the monitor, showing gray arrows; and

FIG. 21 is a screen shot of a display presented on the monitor, showing adjustment arrows.

### DETAILED DESCRIPTION OF THE PREFERRED EMBODIMENTS

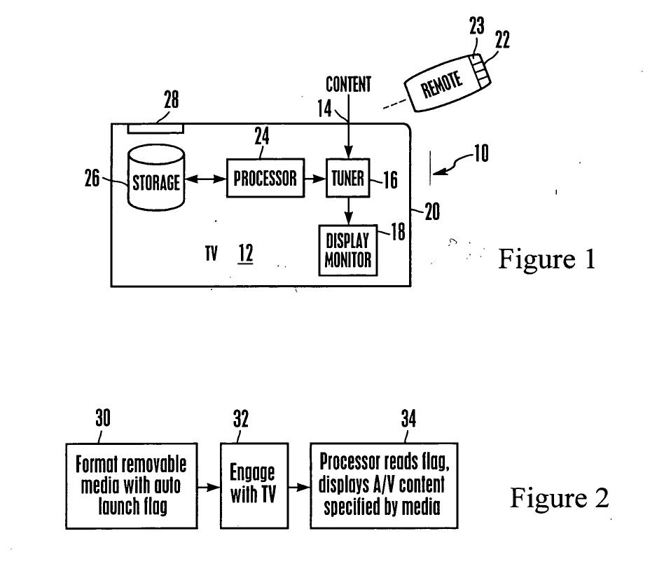

Referring initially to FIG. 1, a system is shown, generally designated 10. As shown, the system 10 includes a TV 12 that conventionally receives televised analog and/or digital content at a content receiver 14 (e.g., an antenna, satellite dish, set-top box, etc.), with a channel being selectable by means of a conventional tuner 16 for display of the content on a monitor 18.

While the embodiment of FIG. 1 shows a TV 12 with a single housing that includes a microprocessor and database, it is to be understood that the term “television” and “television system” encompasses any apparatus that has a television tuner and the below-described capability in a single housing or in separate housings that cooperate together. For instance, the term “TV” encompasses the television system shown in FIG. 1, as well as a conventional television in combination with a set-top box that functions in accordance with the present invention. In the latter example, the set-top box might include, e.g., the microprocessor discussed below.

In the preferred non-limiting embodiment shown, the TV 12 includes a housing 20 that holds the conventional television tuner 16 which receives the TV signals. One or more viewer input devices, such as but not limited to a wireless TV remote control device 22, can be used in accordance with principles discussed further below. The remote control device can have a numeric keypad 23.

A microprocessor 24 communicates with the TV circuitry for executing various user interface (U/I) logic in accordance with the disclosure below. As intimated above, the microprocessor 24 can be located in the housing 20 or it can be disposed elsewhere, such as in a set-top box, remote control device, or other component. In any case, the microprocessor 24 executes the logic set forth herein. The microprocessor 24 can also access a data storage 26 contained in computer memory, or on a hard disk drive, optical drive, solid state storage, tape drive, removable flash memory such as a Sony Memory Stick® that can be removably engaged with a receptacle 28 in the TV, or any other suitable data storage medium and potentially accessible to a network such as the Internet.

It is to be understood that the flow charts and/or other logic herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessor as a series of computer-executable instructions. In addition to residing on hard disk drives, these instructions may reside, for example, in RAM of the appropriate computer, or the instructions may be stored on magnetic tape, electronic read-only memory, or other appropriate data storage device.

For instance, FIG. 2 shows the logic that can be used when the storage 26 shown in FIG. 1 is a removable memory medium that can be removably engaged with the receptacle 28. Commencing at block 30, the removable medium can be formatted with a flag indicating that a display should be automatically launched upon engagement with the receptacle 28, which engagement can be undertaken at block 32. Proceeding to block 34, the processor 24 shown in FIG. 1 reads the flag, which indicates an audio and/or video content display to be automatically presented on the TV without further action by the user. The content can be supplied by application information in the removable memory medium or in permanent storage or other source internal to the TV apart from the removable memory medium. As set forth further below, a media viewer application may be launched, and/or a “slide show” presentation mode entered, when the removable medium is engaged with the TV system 10.

Thus, the presence of removable media is automatically detected (in one embodiment, using the above-mentioned flag), and a viewer application invoked for viewing the media and automatically initiating a multimedia presentation mode. In this way, the user need do nothing more after engaging the medium with the receptacle to switch to the appropriate television mode. Accordingly, the user need not understand the application controls enough to know how to initiate the presentation or slide show mode, or to know how to select specific content on the removable media, or to know how to select specific background audio.

In addition to the auto launch flag, the removable medium can be formatted with settings for background audio playback. As mentioned above, the settings for the application associated with the removable medium may be stored on the application itself when the application is stored inside the TV, while other settings may be stored within the removable memory medium, in which case memory medium's settings override the settings on the application.

The flag written in the removable medium may indicate that the medium is a ‘demonstration’, which can cause the associated application to automatically enter a “Slide Show” mode in which the “Contents” setting of the TV is set to read whatever folder is specified by the removable media, and the “Music” setting is set to play whatever audio setting is currently written on the removable media. The visual contents may include but are not limited to JPEG digital still photos and MPEG I motion video. The audio contents may include but are not limited to multiple forms of MP3 audio files, and MPEG 1 audio that accompanies JPEG still photos in the form of “voice memos” tagging digital photos. It may now be appreciated that the TV system 10 automatically enters the display mode discussed above when the medium is engaged with the receptacle to invoke an application and/or to enter the above-discussed “Slide Show” mode.

Because some media viewer application settings may be contained on the memory medium itself, application settings can be volume-specific and thus can be applicable to the particular medium rather than dependent on the global settings in the TV itself. These settings are settings that pertain to the specific contents of the storage medium and can, as mentioned above, include a “Contents” selection, as well as a “Background Audio” selection, both functions depending on the content of the memory card.

Consequently, once the media viewer mode is automatically entered, an application executed by the processor 24 shown in FIG. 1 can search for a flag on the memory medium to denote ‘automatic launch’ behavior of the application when the flag is detected on any storage media read by the TV processor 24. Further, the storage medium may be handled with a task-oriented approach from the user's standpoint, so rather than the user needing to know anything about the system itself, the user only needs to know that their desired content exists on the particular removable medium.

Enhancements of the above processing can include automatic volume and picture adjustment for optimal viewing experience, based on data on the removable memory medium. The user may override these settings at any time, but the supplier of the contents on the removable media nevertheless may customize the picture and sound settings as a starting point or default condition for the given removable media contents. Also, the user can be allowed to designate a particular memory medium to be handled with the above-disclosed automatic launch functionality, or all memory media may automatically launch a media viewer application, with only special ROM (read-only-memory) media containing a flag for launching the “slide show” mode. This latter flag may be set by the application itself, if so chosen by the user.

The logic above also facilitates promotional uses, such as still-photo slide shows with background audio (music or other audio files) custom selected to accompany the particular images. Examples of this can include music releases from music artists, along with still images of the artists, movie promos, with MPEG I movie trailers, accompanied with movie stills and movie soundtracks in the background, promotional or demonstration reels for advertising agencies and other creative agencies, product announcements or lineup descriptions that are automatically running on the dealer retail floor or at tradeshows, or other venues in which the product manufacturer (author of the contents on the memory medium) desires to present their information in a particular way, without the need for extensive training of dealers or tradeshow representatives, and instructional videos that might be helpful to include with the TV system 10 itself. For instance, easy setup or usage instructions with audio and video content could be placed on the memory medium and shipped with the product.

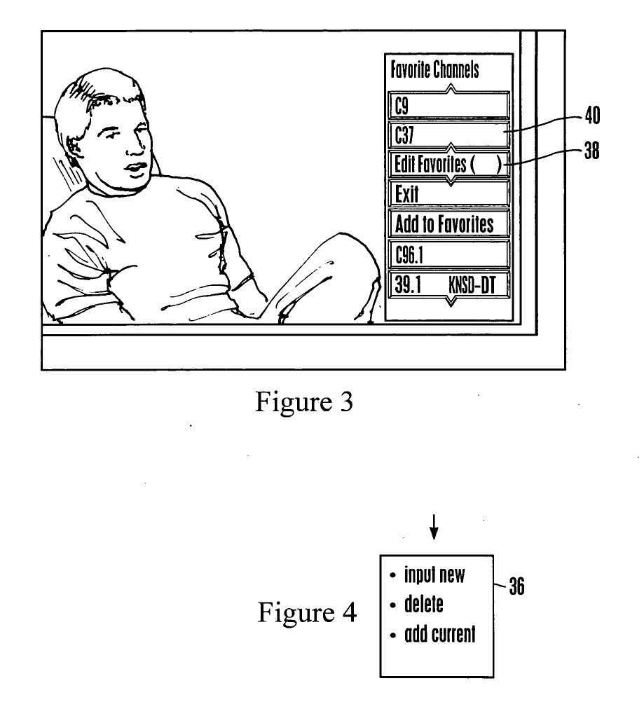

FIGS. 3 and 4 illustrate another inventive feature, namely, the provision of the ability to directly access an “edit favorites” menu 36 (FIG. 4) by selecting an “edit favorites” button 38 of a main menu 40 (FIG. 3), in the case shown, a favorite channels menu. This feature allows the user to go directly to the Edit Favorites menu in the regular graphic user interface (GUI) main menu. Previous to the present invention, a user was forced to navigate through to a fourth layer menu to access the Edit Favorites menu and establish or modify the favorite channel list, which required the user to know how to navigate through multiple menus.

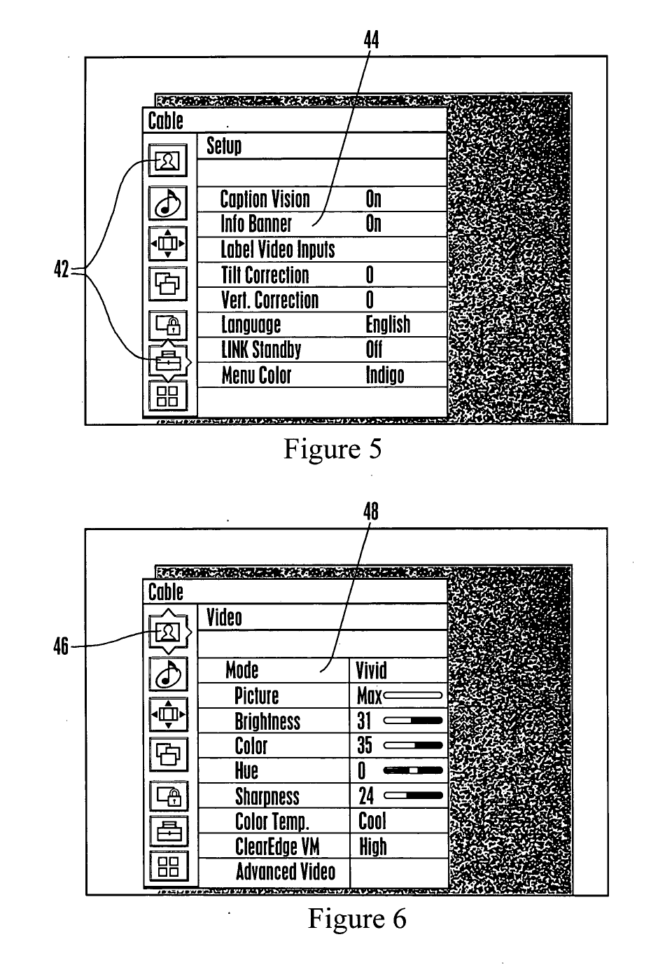

FIGS. 5-11 illustrate various icons and associated menus of the present GUI. In FIG. 5, a setup icon 42 can be selected to cause a setup menu 44 to be displayed on the monitor 18 shown in FIG. 1. The setup icon can resemble stacked blocks, and the setup menu 44 can include selections such as “caption vision on/off”, “info banner on/off”, “label video inputs”, “tilt correction”, “vertical correction”, “language” selection, “link standby on/off”, and, as more fully disclosed below, “menu color selection”.

FIG. 6 shows that a video icon 46, which can resemble a human figure in a box, can be selected to cause a menu 48 of video settings to be displayed on the monitor. The menu can include conventional entries for mode, picture, brightness, color, hue, sharpness, color temperature, as well as “clear edge VM” and advanced video settings.

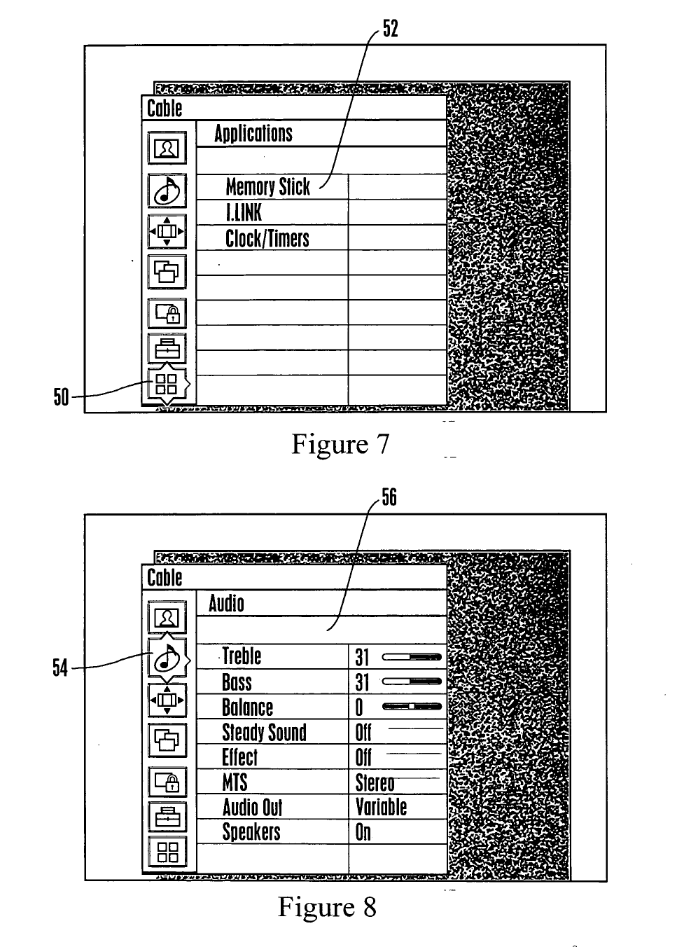

In contrast, FIG. 7 shows an applications icon 50 that can resemble a quartered box and that can be selected to cause an applications menu 52 to appear on the monitor, listing various software applications that may be executed by the processor 24.

FIG. 8 shows an audio icon 54 resembling a music note that can be selected to cause a menu 56 of audio settings to be displayed on the monitor. The audio settings may include conventional settings such as treble, bass, balance, as well as “steady sound on/off”, “effect on/off”, “MTS (e.g., stereo)”, “audio out”, and “speaker on/off”.

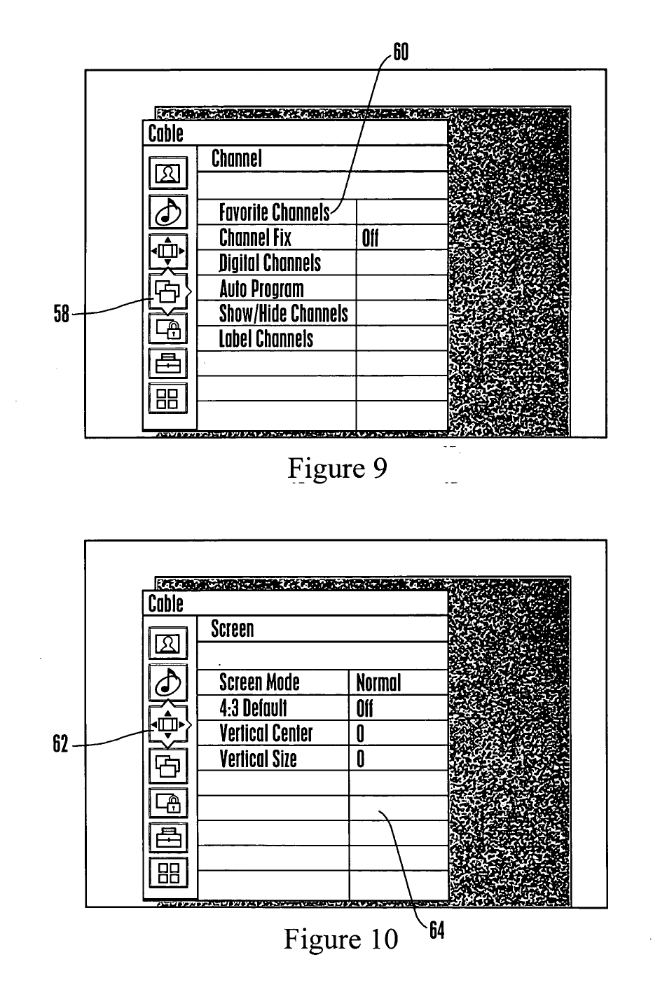

In FIG. 9, a channel icon 58 that can include plural boxes overlaid on each other can be selected to cause a channel menu 60 to be displayed on the monitor. The channel menu 60 may include selections for favorite channels, channel fix (on/off), digital channels, automatic program, show/hide channels, and label channels.

FIG. 10 shows that a screen icon 62, which may resemble a TV screen, may be selected to cause a screen menu 64 to be displayed on the monitor. The screen menu 64 may include selections for establishing screen mode, aspect ratio default, vertical center, and vertical size.

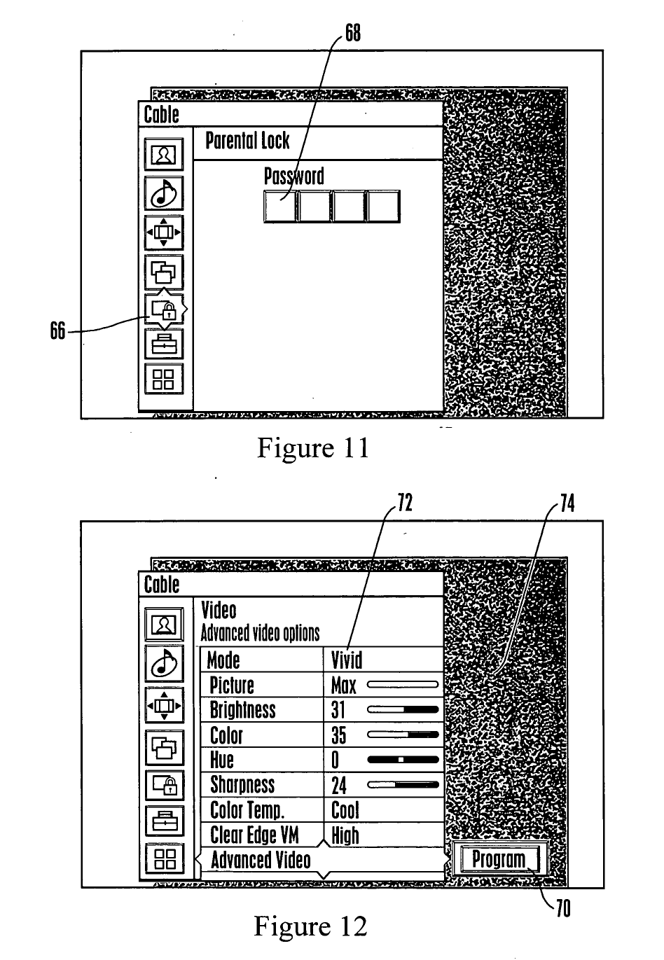

A parental lock icon 66 that can include an image of a lock is shown in FIG. 11. The lock icon 66 can be selected to cause a menu 68 of parental controls to be displayed on the monitor. The menu 68 can include a box for entering a password.

FIG. 12 shows that a related hierarchical series of three or more menus may be simultaneously presented on the monitor 18 so that all three or more menus in the layer are presented at the same time, facilitating knowledge of where the cursor is in the menu structure. In specific embodiments, a lower layer menu 70 may be displayed on top of or next to a next higher layer menu 72, which in turn is displayed on top of or next to a highest layer menu 74, with at least portions of all menus in the structure being visible, in essence providing a “crumb trail” to the user that allows the user to easily determine the current location in the menu structure. In some implementations there is no overlap between the first three menu layers, but a fourth layer menu when invoked partially overlaps the second layer menu, a sixth layer menu when invoked partially overlaps the fourth layer menu, etc.

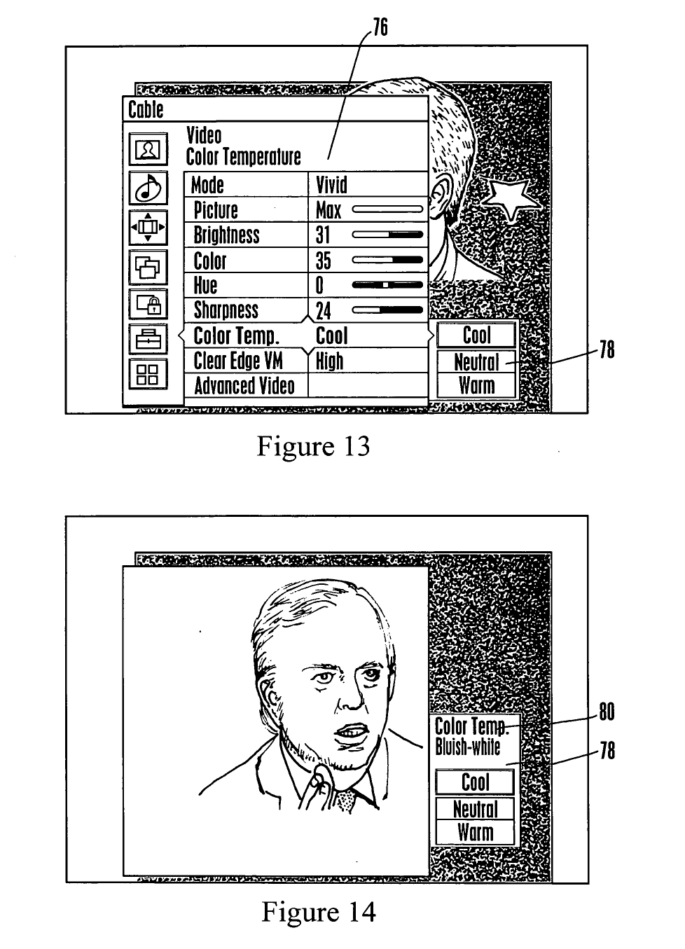

FIGS. 13 and 14 illustrate an “orphan menus” feature that may be provided, in contrast to the layered menus shown in FIG. 12. The feature shown in FIGS. 13 and 14 provides more visible area of the TV screen to the user when making adjustments to the video settings. As recognized herein, because some video adjustment menus can cover a large portion of the screen, a user may be prevented from seeing enough video to determine the effect of a video adjustment change. Accordingly, main menus such as the main video menu 76 shown in FIG. 13 are hidden when the cursor is positioned over a lower layer menu 78 (FIG. 14), with the lower layer menu 78 remaining in the same position on the screen it occupied when the main menu 76 was presented. When the user presses <Select/Left> or other behavior that returns the cursor to the next higher layer menu, that menu reappears.

Furthermore, if desired help text 80 can be made to appear above the lower layer menu 78 as shown in FIG. 14.

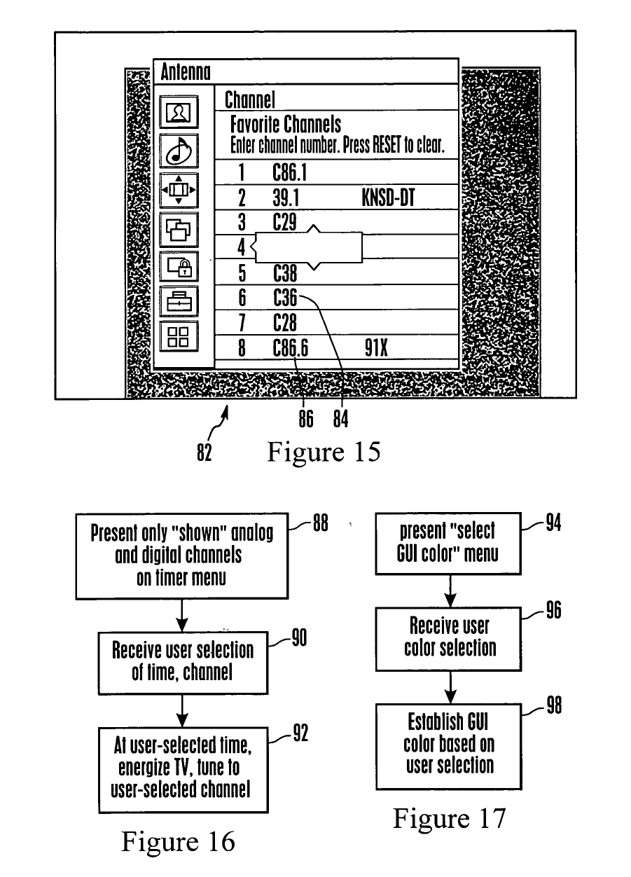

FIG. 15 shows an edit favorites menu 82 which contains both analog channels 84 (e.g., “channel 36”) and, unlike conventional edit favorites menu, digital channels (e.g., “channel 86.6”) 86. Furthermore, a user can directly enter a numeric string into the menu 82 using the keypad 23 of the remote control device 22 shown in FIG. 1, with the string representing a channel number, instead of having to access a channel list and scroll through the list until the cursor is over the desired channel, although this form of entering a channel on the favorites channel list is provided as well.

FIG. 16 shows the logic that may be implemented to allow not only analog channels to be designated “wake up” channels when the conventional “timer” function is invoked, but digital channels as well. Commencing at block 88 only a “shown” channels list (usually established by the user) is presented, listing only those analog and digital channels desired by the user to be shown on the electronic program guide displayed by the processor 24.

Moving to block 90, the user can manipulate the remote control device 22 shown in FIG. 1 to input a desired wake-up time and channel (analog or digital) the user desires the TV to be tuned to at the desired time, and these selections are received by the processor 24. At block 92 the TV is energized (if off) and the desired channel tuned to when the desired time arrives.

As recognized herein, the primary reason heretofore for excluding digital channels from being programmed as the wake up channel was the sheer number of potential channels, from 1.1-999.999, scrolling through which to program a wake up channel is not feasible. However, the present invention presents only channels in the “shown” channel list when the “timer” function is invoked, ignoring hypothetical digital channels and thus solving the size problem of the digital channel list.

FIG. 17 shows the logic that can be followed for establishing the color of all or a portion of the present GUI, a feature that otherwise is not provided to users. Commencing at block 94, a “select color” menu is presented on the monitor 18, and at block 96 the user's color selection is received. The color of one or more menus of the GUI are established accordingly at block 98 by appropriately manipulating the remote control device 22.

In non-limiting implementations, five color selections plus translucent may be provided. For example, for monitors 18 that are cathode ray tubes (CRT), the user may select GUI colors of gray, red, green, indigo, and tan, whereas for CPJ, GW, and SXRD monitors the colors may be gray, red, green, indigo, purple. For PDP and LCD displays the colors may be gray, red, aqua, tan, and purple.

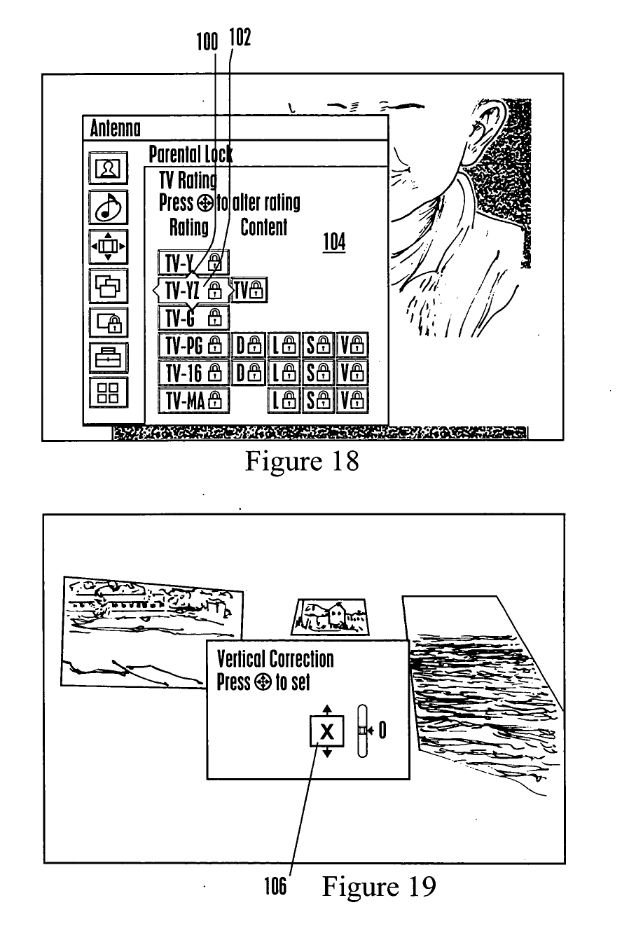

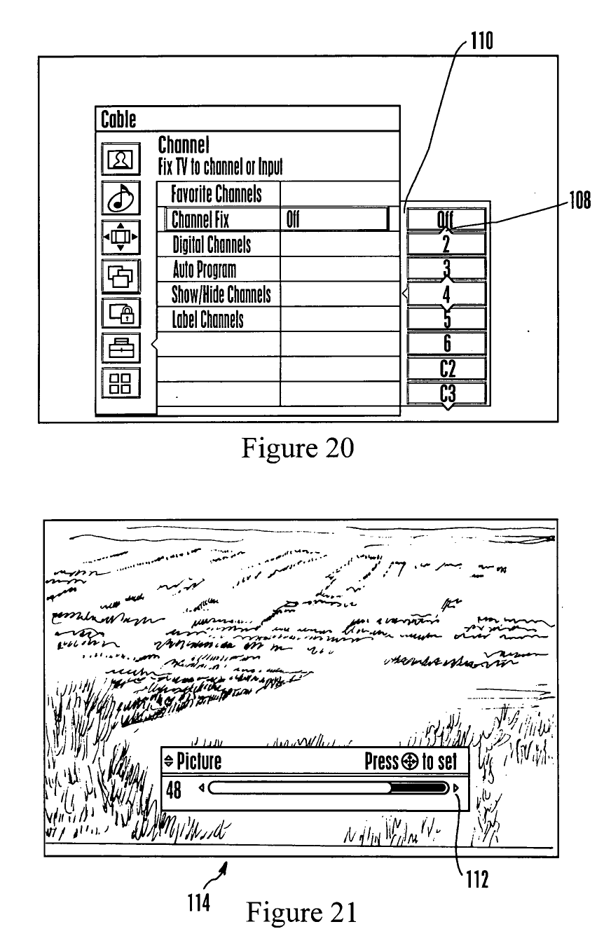

FIGS. 18-21 show various inventive navigation arrows that may be used. In FIG. 18, cursor arrows 100 are shown that are part of a screen cursor 102 and move with the screen cursor 102 as the cursor moves across a GUI menu 104. The cursor arrows 100 are thus superimposed on the screen cursor 102. FIG. 19, on the other hand, shows detached arrows 106 that are not connected to other visible parts of the GUI, while FIG. 20 shows gray arrows 108 on a menu 110 that indicate that the list shown has further entries, top and bottom. Adjustment arrows 112 in FIG. 21 are displayed on an adjustment screen 114 and are respectively selectable to cause a previous and next adjustment screen of the GUI to appear, and/or to slide the adjustment bar shown.

With more specificity regarding the active arrows discussed above, the cursor arrows are incorporated into the cursor, and if cursor navigation is possible, the button includes an arrow in the direction of the possible navigation. Detached arrows indicate that there are items not currently shown on the screen. For example, the Channel Label screen permits the user to select from a group of letter, numbers and symbols to create a custom label for a channel, but not all characters are displayed at the same time, so the user must scroll through the list with the Up/Down controls on the remote control device 22. Such an interface advantageously can use the detached arrows 106 shown in FIG. 19. For scrolling menus with items that do not appear on the screen due to the length of the scrollable list, the gray arrows 108 of FIG. 20 can be used. The adjustment arrows 112 in FIG. 21 can indicate to the user that by pressing up or down on the remote control device 22, the GUI will display the previous or next adjustment bar.

While the particular NAVIGATION AIDS FOR TELEVISION USER INTERFACE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for”.

WE CLAIM:

What is claimed is:

1. A TV system, comprising:
at least one TV tuner receiving TV content;
at least one TV monitor for displaying the TV content;
at least one processor communicating with the tuner and monitor; and
at least one receptacle communicating with the processor and configured for removably receiving a portable memory device, the processor automatically causing an audio display and/or a visual display associated with at least data on the portable memory device to be displayed on the monitor in response to the portable memory device being engaged with the receptacle.

2. The system of claim 1, wherein the portable memory device stores a flag indicating to the processor to automatically establish a display.

3. The system of claim 2, wherein the processor automatically establishes the display using application information on the memory device.

4. The system of claim 2, wherein the processor automatically establishes the display using application information on a permanent storage internal to the TV system.

5. A TV system, comprising:
at least one TV tuner receiving TV content;
at least one TV monitor for displaying the TV content; and
at least one processor communicating with the tuner and monitor, the processor causing a graphical user interface (GUI) to be displayed on the monitor, the GUI including a main menu, the main menu including an edit favorites button which, when selected by a user, presents a GUI menu enabling a user to establish a favorite TV channels list.

6. The system of claim 5, wherein the main menu is a surf favorite channels menu.

7. A TV system, comprising:
at least one TV tuner receiving TV content;
at least one TV monitor for displaying the TV content; and
at least one processor communicating with the tuner and monitor, the processor causing a graphical user interface (GUI) to be displayed on the monitor, the GUI including at least one computer icon selected from the group of icons consisting of: a music note icon selectable to cause a menu of audio settings to be displayed on the monitor, a video icon including a figure in a box and selectable to cause a menu of video settings to be displayed on the monitor, an applications icon selectable to cause a menu of applications to be displayed on the monitor, a channel icon including plural boxes overlaid on each other and selectable to cause a channel menu to be displayed on the monitor, a screen icon selectable to cause a screen menu to be displayed on the monitor, a parental lock icon including at least one image of a lock and selectable to cause a menu of parental controls to be displayed on the monitor, and a setup icon selectable to cause a setup menu to be displayed on the monitor.

8. The TV system of claim 7, wherein the computer icon is a music note icon selectable to cause a menu of audio settings to be displayed on the monitor.

9. The TV system of claim 7, wherein the computer icon is a video icon including a figure in a box and selectable to cause a menu of video settings to be displayed on the monitor.

10. The TV system of claim 7, wherein the computer icon is an applications icon selectable to cause a menu of applications to be displayed on the monitor.

11. The TV system of claim 7, wherein the computer icon is a channel icon including plural boxes overlaid on each other and selectable to cause a channel menu to be displayed on the monitor.

12. The TV system of claim 7, wherein the computer icon is a screen icon selectable to cause a screen menu to be displayed on the monitor.

13. The TV system of claim 7, wherein the computer icon is a parental lock icon including at least one image of a lock and selectable to cause a menu of parental controls to be displayed on the monitor.

14. The TV system of claim 7, wherein the computer icon is a setup icon selectable to cause a setup menu to be displayed on the monitor.

15. A TV system, comprising:
at least one TV tuner receiving TV content;
at least one TV monitor for displaying the TV content; and
at least one processor communicating with the tuner and monitor, the processor causing a graphical user interface (GUI) to be displayed on the monitor, the GUI including at least a main menu, a second layer menu being a descendant of the main menu, and a third layer menu being a descendant of the second layer menu, the processor causing all three menus to be displayed simultaneously on the monitor at least part of the time in a configuration such that a user can view at least a portion of each of the three menus.

16. A TV system, comprising:
at least one TV tuner receiving TV content;
at least one TV monitor for displaying the TV content; and
at least one processor communicating with the tuner and monitor, the processor causing a graphical user interface (GUI) to be displayed on the monitor, the GUI including at least a main menu, a second layer menu being a descendant of the main menu, and a third layer menu being a descendant of the second layer menu, the processor causing only, at least part of the time, the third layer menu to be displayed when it is selected and causing the main and second layer menus to disappear from the display when a cursor is over the third layer menu.

17. The system of claim 16, wherein the third layer menu is a video settings menu.

18. The system of claim 17, wherein the processor causes help text to appear above the third layer menu when the other two menus disappear.

19. A TV system, comprising:
at least one TV tuner receiving TV content;
at least one TV monitor for displaying the TV content; and
at least one processor communicating with the tuner and monitor, the processor causing a graphical user interface (GUI) to be displayed on the monitor, the GUI including at least a favorite channel list listing both analog and digital channels, the favorite channel list being established by a user.

20. The system of claim 19, comprising a remote control device in wireless communication with the processor and containing a numeric keypad, a desired channel being enterable into the favorite channel list by a user inputting a numeric value representing the desired channel using the keypad.

21. A TV system, comprising:
at least one TV tuner receiving TV content;
at least one TV monitor for displaying the TV content;
at least one processor communicating with the tuner and monitor, the processor causing a graphical user interface (GUI) to be displayed on the monitor, the GUI including at least one shown channel list established by a user to display only analog and digital channels desired by the user to be shown on the list; and
a remote control device in wireless communication with the processor and manipulable by a user to select a time and a channel from the shown channel list to be automatically played on the monitor at the selected time.

22. A TV system, comprising:
at least one TV tuner receiving TV content;
at least one TV monitor for displaying the TV content;
at least one processor communicating with the tuner and monitor, the processor causing a graphical user interface (GUI) to be displayed on the monitor; and
a remote control device in wireless communication with the processor and manipulable by a user to select a color for at least one menu of the GUI.

23. A TV system, comprising:
at least one TV tuner receiving TV content;
at least one TV monitor for displaying the TV content; and
at least one processor communicating with the tuner and monitor, the processor causing a graphical user interface (GUI) to be displayed on the monitor, the GUI displaying arrows selected from the group including cursor arrows superimposed on a screen cursor, detached arrows not connected to a visible part of the GUI, and adjustment arrows displayable on an adjustment screen and respectively selectable to cause a previous and next adjustment screen of the GUI to appear.

24. The system of claim 23, wherein the arrows are cursor arrows superimposed on a screen cursor.

25. The system of claim 23, wherein the arrows are detached arrows not connected to a visible part of the GUI.

26. The system of claim 23, wherein the arrows are adjustment arrows displayable on an adjustment screen and respectively selectable to cause a previous and next adjustment screen of the GUI to appear.
